(19) United States
(12) Patent Application Publication
(10) Pub. No.: US 2022/0398507 A1
(43) Pub. Date: Dec. 15, 2022

(54) INFORMATION PROCESSING DEVICE, INFORMATION PROCESSING SYSTEM, AND INFORMATION PROCESSING METHOD

(71) Applicant: TOYOTA JIDOSHA KABUSHIKI KAISHA, Toyota-shi (JP)

(72) Inventors: NAOYA OKA, Nagakute-shi (JP); Satoshi Kitamura, Nagoya-shi (JP); Yusuke Sobue, Nagoya-shi (JP); Seira Nakada, Nagoya-shi (JP); Mami Mori, Nagoya-shi (JP); Masato Morishima, Nagoya-shi (JP); Yasuyuki Nunokawa, Nagoya-shi (JP)

(73) Assignee: TOYOTA JIDOSHA KABUSHIKI KAISHA, Toyota-shi (JP)

(21) Appl. No.: 17/747,090

(22) Filed: May 18, 2022

(30) Foreign Application Priority Data
Jun. 10, 2021 (JP) 2021-097512

(51) Int. Cl. G06Q 10/02; G06Q 30/06; G06Q 50/30

(52) U.S. Cl. CPC G06Q 10/02; G06Q 30/0645; G06Q 50/30

(57) ABSTRACT

An information processing device provides a first service related to movement online. The information processing device includes a processor. The processor is configured to perform a first process regarding a reservation for a service a user is going to receive at a destination, and perform a second process regarding a reservation for transportation the user is going to use. The processor is configured not to perform the second process when the user is using a second service that is a service for renting a vehicle and is going to use the first service.

### CROSS-REFERENCE TO RELATED APPLICATION

This application claims priority to Japanese Patent Application No. 2021-097512 filed on Jun. 10, 2021, incorporated herein by reference in its entirety.

### BACKGROUND

### 1. Technical Field

The present disclosure relates to information processing devices, information processing systems, and information processing methods.

### 2. Description of Related Art

A type of contract is known which allows a user to rent a vehicle for a certain period of time. This type of contract is also called a lease contract, a subscription contract, etc. For example, Japanese Unexamined Patent Application Publication No. 2015-122107 (JP 2015-122107 A) discloses, as an disclosure related to this type of contract, a system that provides a car wash service to users free of charge depending on whether they have a lease contract.

### SUMMARY

It is an object of the present disclosure to provide convenience to users who use a service related to movement.

A first aspect of the present disclosure relates to an information processing device that provides a first service related to movement online. The information processing device includes a processor. The processor is configured to: perform a first process regarding a reservation for a service a user is going to receive at a destination, and perform a second process regarding a reservation for transportation the user is going to use. The processor is configured not to perform the second process when the user is using a second service that is a service for renting a vehicle and is going to use the first service.

A second aspect of the present disclosure relates to an information processing system. The information processing system includes a first server and a second server. The first server provides a first service related to movement online. The first server includes a processor. The processor is configured to perform a first process regarding a reservation for a service a user is going to receive at a destination and a second process regarding a reservation for transportation the user is going to use. The processor is configured not to perform the second process when the user is using a second service that is a service for renting a vehicle and is going to use the first service. The second server is associated with the second service. The second server is configured to provide data on a usage status of the second service by the user to the first server.

A third aspect of the present disclosure relates to an information processing method that provides a first service related to movement online. The information processing method includes: performing a process regarding a reservation for a service a user is going to receive at a destination by a computer; and performing a process regarding a reservation for transportation the user is going to use by the computer when the user is not using a second service that is a service for renting a vehicle, and not performing the process regarding the reservation for transportation the user is going to use by the computer when the user is using the second service and is going to use the first service.

The present disclosure can provide convenience users who use the service related to movement.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 illustrate an overview of a reservation system;

FIG. 2 illustrates configurations of a reservation server and a user terminal;

FIG. 3 shows an example of contract data stored in a storage unit;

FIG. 4 illustrates an itinerary associated with a user;

FIG. 5 shows an example of spot data stored in the storage unit;

FIG. 6 shows an example of plan data stored in the storage unit;

FIG. 7 shows an example of reservation data generated by the reservation server;

FIG. 8 is a flowchart of a process that is performed by a control unit in a first embodiment;

FIG. 9 shows an example of a screen for searching for spots;

FIG. 10 shows an example of a screen for searching for plans;

FIG. 11 is a flowchart of a process that is performed by the control unit in the first embodiment;

FIG. 12 shows an example of a screen for confirming a plan;

FIG. 13 shows an example of a screen for selecting a means of transportation;

FIG. 14 is a flowchart of a process that is performed by a control unit in a second embodiment;

FIG. 15 shows an example of travel product data according to the second embodiment; and

FIG. 16 shows an example of a screen provided to a user in the second embodiment.

### DETAILED DESCRIPTION OF EMBODIMENTS

An information processing device according to one aspect of the present disclosure is an information processing device that provides a first service related to movement online. The information processing device includes a processor. The processor is configured to perform a first process regarding a reservation for a service a user is going to receive at a destination, and a second process regarding a reservation for transportation the user is going to use. The processor is configured not to perform the second process when the user is using a second service that is a service for renting a vehicle and is going to use the first service.

Other aspect of the present disclosure relates to a program that causes a computer to perform a method to be performed by the information processing device, or a computer-readable storage medium storing the program in a non-transitory manner.

A type of contract is known which allows a user to rent a car for a contract period in exchange for regular fee payments (this type of contract is also called “lease” or “subscription”). The same business operator as that rents vehicles may provide a service related to movement (first service) in order to have the user make use of the rented vehicle. Examples of the first service includes a service for generating a travel plan and a service for making all reservations for a plurality of spots the user is going to visit during a trip at a time. The information processing device according to the present disclosure provides such a service. The terms “travel” and “trip” as used herein represent a concept including not only movement for leisure purposes but also mere movement.

There are also cases where it is not necessary to provide transportation to the user who is renting a vehicle. Therefore, the information processing device according to the present disclosure allows the user who is using the second service (who is renting a vehicle) to skip the process regarding the reservation for transportation.

For example, the process regarding the reservation for transportation means may be a process of collecting information necessary to book transportation from the user, or may be a process of booking transportation based on the collected information.
This provides convenience to users who use the first service.

The processor may be configured to provide a plurality of user interface screens to the user, and the processor may be configured not to provide at least a part of the user interface screens regarding the reservation for transportation when the user is using the second service.

The processor may be configured to propose to the user to skip the process regarding the reservation for transportation when the user is using the second service. Since provision of unnecessary screens is omitted, the service can be provided quickly.

The processor may be configured to make a reservation for one or more spots the user is going to visit during the movement in the first process.

Examples of the spots include accommodations, restaurants, and parking lots.

The processor may be configured to book public transportation in the second process.

The public transportation includes, for example, trains, taxis, buses, and airplanes.

An operator of the first service may be the same business operator as an operator of the second service or may be a business operator related to the operator of the second service.

Examples of the related business operators include group companies, companies with capital ties, a parent company and its subsidiary, and business operators that have signed a contract.

The processor may be configured to acquire data on a usage status of the second service by the user.

The processor may acquire the data on the usage status of the second service from, for example, an external device that manages vehicle rental contracts.

The data may include information on a seating capacity of a first vehicle rented to the user.

The processor may be configured not to perform the second process when the number of people involved in the movement is smaller than the seating capacity of the first vehicle. The processor may be configured to propose to the user to book a second vehicle with a larger seating capacity than the first vehicle when the number of people involved in the movement is larger than the seating capacity of the first vehicle.
According to such a configuration, the second process can be skipped only when movement using the first vehicle is not possible. Moreover, alternative transportation can be proposed.

Hereinafter, specific embodiments of the present disclosure will be described with reference to the drawings. The hardware configuration, module configuration, functional configuration, etc. described in each embodiment are not intended to limit the technical scope of the disclosure to these configurations unless otherwise specified.

### First Embodiment

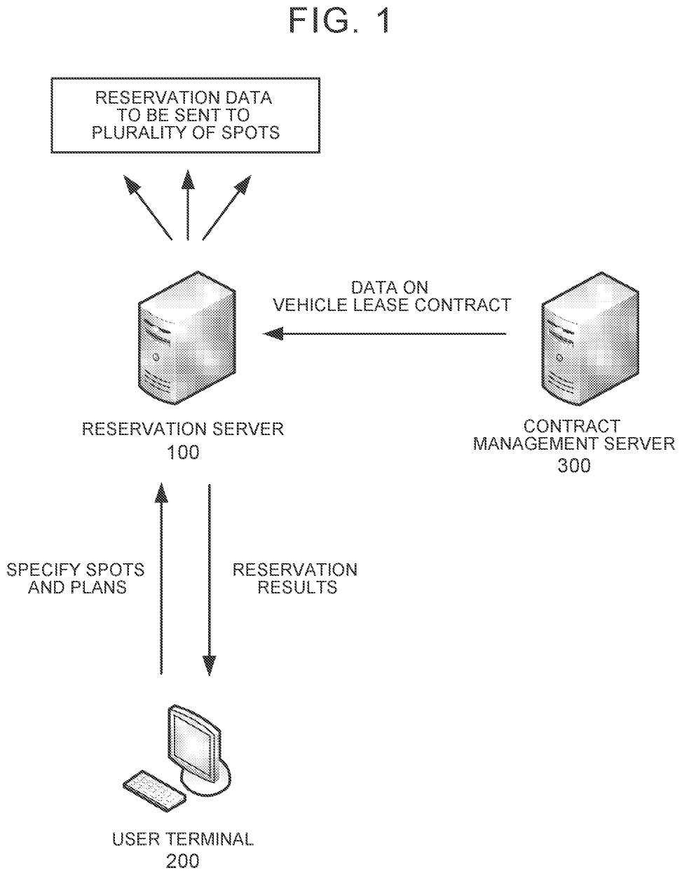

An overview of a reservation system according to a first embodiment will be given with reference to FIG. 1. The reservation system according to the present embodiment includes: a plurality of spots (e.g., accommodations and restaurants); a reservation server 100 for booking all transportation to desired spots at a time; a user terminal 200; and a contract management server 300 for managing vehicle lease contracts. In the following description, a vehicle rental contract is referred to as “lease contract.”

The reservation server 100 is a device that generates reservation data for making reservations for a plurality of pre-registered spots based on a request sent from the user terminal 200. The reservation server 100 manages the plurality of spots and plans provided at the spots, and can make reservations for desired spots and plans based on a request from a user. The reservation server 100 can also book transportation the user is going to use.

The reservation service provided by the reservation server 100 is operated by a first business operator.

The user terminal 200 is a computer carried by a user who uses the reservation service. The user can access the reservation server 100 via the user terminal 200 and request to make reservations for a plurality of spots and transportation. The user may send desired conditions (e.g., desired area, desired spot attributes, departure time, etc.) to the reservation server 100.

The contract management server 300 is a server device that manages vehicle lease contracts users have with the first business operator. In the present embodiment, the vehicle lease contract is a contract that allows the user to register with a public institution as a user of a vehicle owned by the first business operator in exchange for monthly usage fee payments. The contract period is determined in advance and can be, for example, about one month to several years.

The contract management server 300 provides information on the vehicle lease contract to the reservation server 100.

It is assumed in the present embodiment that the business operator that provides the reservation service and the business operator that provides the vehicle leasing service are the same business operator. However, these business operators may be substantially the same. Examples of such a relationship include group companies, companies with capital ties, and a parent company and its subsidiary. The “same business operator” as used in the present disclosure also includes such relationships. The business operator that provides the reservation service and the business operator that provides the vehicle leasing service may be business operators that are not related to each other. The user can use the reservation service provided by the reservation server 100 regardless of whether the user has a vehicle lease contract.

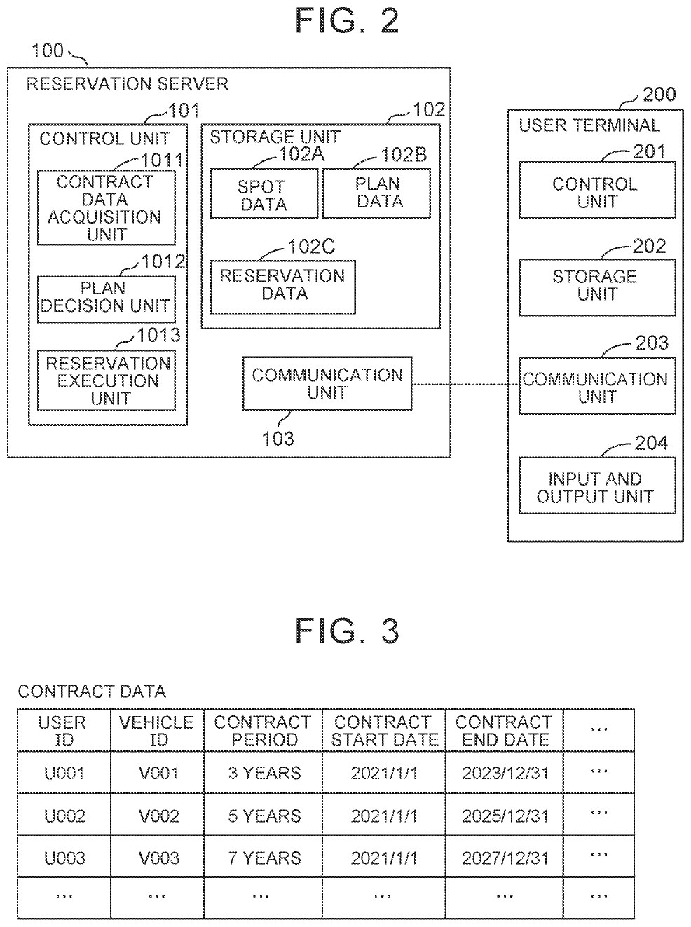

FIG. 2 shows in more detail the components of the reservation server 100 and the user terminal 200 included in the information processing system according to the present embodiment. First, the user terminal 200 will be described.

The user terminal 200 is a computer that is used by an individual, such as a personal computer, a smartphone, a mobile phone, a tablet computer, or a personal digital assistant. The user terminal 200 includes a control unit 201, a storage unit 202, a communication unit 203, and an input and output unit 204.

The control unit 201 is an arithmetic unit responsible for control that is performed by the user terminal 200. The control unit 201 can be implemented by an arithmetic processing unit such as a central processing unit (CPU).

The control unit 201 executes a function to access and interact with the reservation server 100. This function may be implemented by a web browser running on the user terminal 200 or by dedicated application software.

The storage unit 202 includes a main storage device and an auxiliary storage device. The main storage device is a memory into which programs to be executed by the control unit 201 and data to be used by the control programs are loaded. The auxiliary storage device is a device that stores the programs to be executed by the control unit 201 and the data to be used by the control programs. The auxiliary storage device may store a package of applications of the programs to be executed by the control unit 201. The auxiliary storage device may store an operating system for running these applications. The programs stored in the auxiliary storage device are loaded into the main storage device and executed by the control unit 201. Processes that will be described later are thus performed.

The main storage device may include a random access memory (RAM) or a read only memory (ROM). The auxiliary storage device may include an erasable programmable ROM (EPROM) or a hard disk drive (HDD). The auxiliary storage device may include a removable medium, that is, a portable recording medium.

The communication unit 203 is a wireless communication interface for connecting the user terminal 200 to a network. The communication unit 203 is configured to communicate with the reservation server 100 via, for example, a wireless local area network (LAN) or a mobile communication service such as third generation (3G), Long-Term Evolution (LTE), or fifth generation (5G).

The input and output unit 204 is a unit that receives an input operation performed by the user and presents information to the user. In the present embodiment, the input and output unit 204 is a single touch panel display. Specifically, the input and output unit 204 is composed of a liquid crystal display and its control means, and a touch panel and its control means.

Next, the reservation server 100 will be described.

The reservation server 100 is a server device that presents the spots and the contents of the plans to the user and makes reservations for desired spots based on a request sent from the user terminal 200. The reservation server 100 also has a function to book transportation.

In the present embodiment, the reservation server 100 may be configured to run a web server for interacting with the user terminal 200. In this case, for example, the user terminal 200 can make reservations for the spots etc. by accessing the web server using a browser. The reservation server 100 may provide a service by means other than the web server. For example, the reservation server 100 may execute a service for interacting with dedicated application software installed in the user terminal 200 by a predetermined protocol.

The reservation server 100 may be a general-purpose computer. That is, the reservation server 100 may be a computer including a processor such as a CPU or a graphics processing unit (GPU), a main storage device such as a RAM or a ROM, and an auxiliary storage device such as an EPROM, a hard disk drive, or a removable medium. An operating system (OS), various programs, various tables, etc. are stored in the auxiliary storage device. The programs stored in the auxiliary storage device are loaded into a work area of the main storage device and executed. Through the execution of the programs, the components etc. are controlled to implement functions that suit a predetermined purpose. Such functions will be described later. Part or all of the functions may be implemented by a hardware circuit such as an application-specific integrated circuit (ASIC) or a field-programmable gate array (FPGA).

A control unit 101 is an arithmetic unit responsible for control that is performed by the reservation server 100. The control unit 101 can be implemented by an arithmetic processing unit such as a CPU.

The control unit 101 includes three functional modules: a contract data acquisition unit 1011, a plan decision unit 1012, and a reservation execution unit 1013. Each functional module may be implemented by the CPU executing stored programs.

The contract data acquisition unit 1011 acquires data on the contract for a leased vehicle (hereinafter referred to as “contract data”) the user has from the contract management server 300. Specifically, the user logged in to the reservation server 100 inquires of the contract management server 300 whether the user has a vehicle lease contract with the first business operator, and receives contract data sent from the contract management server 300 in response to the inquiry.

FIG. 3 is an example of the contract data. The contract data may include, for example, a user identifier, a contracted vehicle identifier, a contract period, contract start and end dates, lease payments, a contract type, and usage conditions.

The plan decision unit 1012 decides spots and plans the user is going to use during a trip based on the results of interaction with the user terminal 200, and generates reservation data.

In the present embodiment, the spots are facilities that are used by users. Examples of the spots include accommodations, restaurants, and entertainment facilities. The spots may be facilities that provide services related to automobiles, such as parking lots, car washes, and gas stations. The spots may be facilities that provide activities and experiences (hands-on facilities). Examples of such facilities include facilities where people can experience specific occupations such as agriculture, sports, cruising, and scenic flights.

In the present embodiment, the plans identify the services provided by each of the spots. When the spot is an accommodation, examples of the plan include “single room for one night,” “single room for one night (with breakfast),” and “double room for one night.” When the spot is a restaurant, examples of the plan include “course meal (lunch)” and “course meal (dinner).” The plan may be designed in any way as long as it can identify the services provided by each spot.

The plan decision unit 1012 decides a combination of the spots the user is going to use during the trip and the plans the user is going to use at each spot. The decided plan is associated with the dates and times the user is scheduled to use the spots.

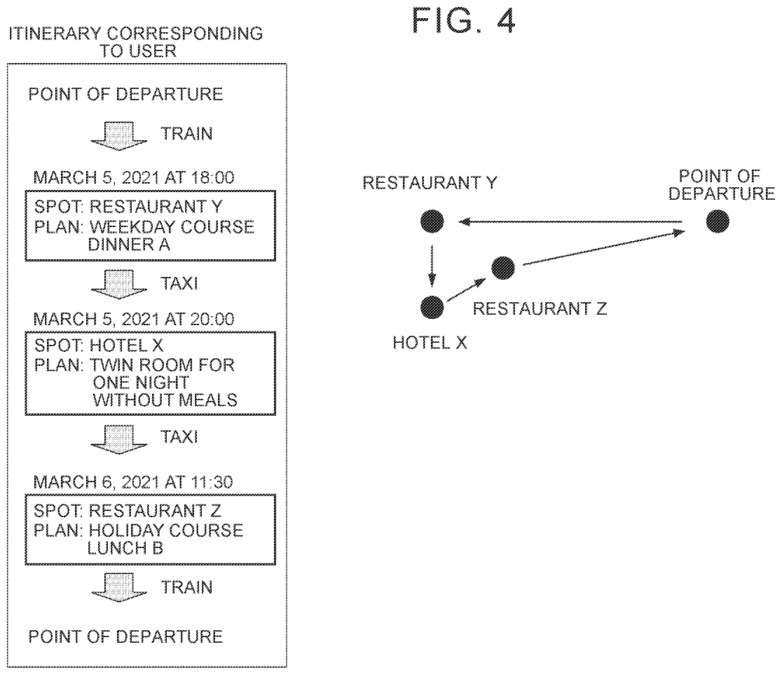

The plan decision unit 1012 also decides the means of transportation the user is going to use during the trip.
The combination of these pieces of information is called an “itinerary.”
FIG. 4 illustrates an example of the itinerary. The illustrated example shows an itinerary in which the user moves by train and taxi, has dinner at a restaurant at the destination, stays overnight at a hotel, has lunch at another restaurant the next day, and returns to the place of departure.

The reservation execution unit 1013 generates data for making reservations for the spots and transportation (reservation data) according to the itinerary generated by the plan decision unit 1012, and sends the data to corresponding external devices. In the example of FIG. 4, the reservation execution unit 1013 sends the reservation data to the three spots. The reservation execution unit 1013 sends the reservation data for booking transportation to external devices corresponding to each means of transportation (e.g., a device for selling reserved train seats and a device for taking taxi dispatch reservations) as necessary.

The user can thus make all the reservations for the facilities etc. and the transportation the user is going to use during the trip at a time.

The storage unit 102 includes a main storage device and an auxiliary storage device. The main storage device is a memory into which programs to be executed by the control unit 101 and data to be used by the control programs are loaded. The auxiliary storage device is a device that stores the programs to be executed by the control unit 101 and the data to be used by the control programs.

The storage unit 102 also stores spot data 102A, plan data 102B, and reservation data 102C.

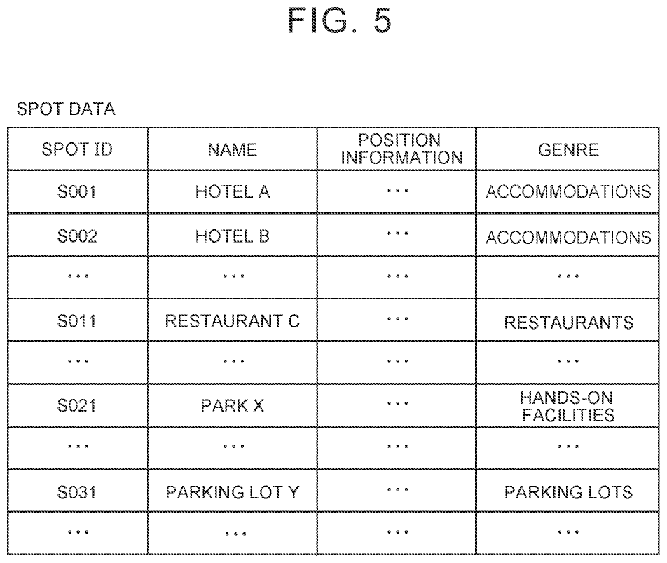

The spot data 102A is data defining a plurality of spots that is used by users. FIG. 5 shows an example of the spot data 102A. The spot data 102A includes, for example, a spot identifier, a spot name, position information of the spot, and information on genre.

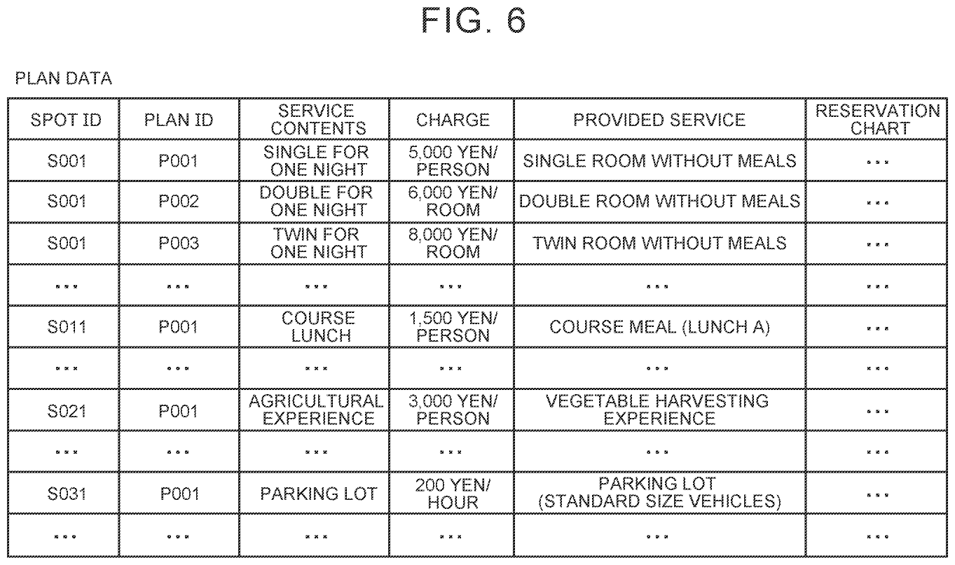

The plan data 102B is data that defines services (plans) provided at each of the spots. FIG. 6 shows an example of the plan data 102B. The plan data 102B includes, for example, a spot identifier, a plan identifier, and data on service contents and charge.

When the service resources that can be provided at each spot (e.g., the number of rooms and the number of seats) are limited, it may be necessary to check availability before taking reservations. In order to deal with this, the plan data 102B may include data for determining whether reservations are possible. An example of such data is a reference to a reservation chart. The plan decision unit 1012 can present whether reservations are possible to the user by accessing the reservation chart via the data. The reservation server 100 may have the reservation chart, or the external devices corresponding to each spot may have the reservation chart.

The reservation data 102C is the reservation data generated by the plan decision unit 1012. The generated reservation data is temporarily stored in the storage unit 102 until it is sent to the external devices.

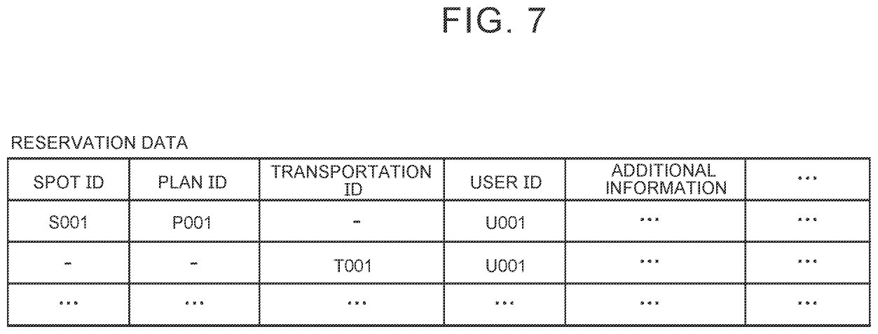

FIG. 7 shows an example of the reservation data 102C. The reservation data 102C includes spot and plan identifiers (when making a reservation for a spot), a transportation identifier (when booking transportation), a user identifier, and additional information. The additional information is additional information required when applying for a reservation. Examples of the additional information include arrival time or check-in time (when making a reservation for a spot), flight, train, or bus number (when booking transportation), number of people, their ages and genders, and user's contact information.

The pieces of data described above may be constructed such that a program of a database management system (DBMS) executed by the processor manages the data stored in the storage device. In this case, these pieces of data may be stored in, for example, a relational database.

The communication unit 103 is a communication interface for connecting the reservation server 100 to the network. The communication unit 103 includes, for example, a network interface board and a wireless communication interface for wireless communication.

The configurations illustrated in FIG. 2 are by way of example, and all or part of the illustrated functions may be executed using circuits designed exclusively for those functions. The programs may be stored in or executed by a combination of a main storage device and an auxiliary storage device other than the illustrated combinations.

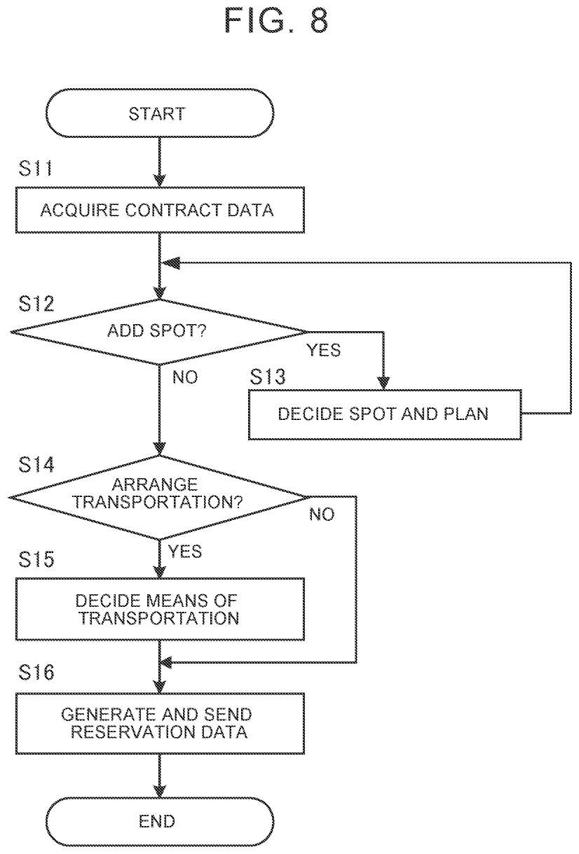

FIG. 8 is a flowchart of a process that is performed by the reservation server 100. For example, the flowchart shown in FIG. 8 is performed when the user logs in to the reservation server 100. It is herein assumed that the reservation server 100 has completed identification of the user at the start of the process.

First, in step S11, the contract data acquisition unit 1011 acquires the contract data corresponding to the user from the contract management server 300. In this step, the contract data acquisition unit 1011 requests the contract management server 300 for data on the contract of the user logged in to the reservation server 100, and acquires the contract data sent in response to the request.

Steps S12 to S15 are steps in which the plan decision unit 1012 creates an itinerary. The plan decision unit 1012 creates an itinerary by adding one or more spots and then deciding the means of transportation.

In step S12, the plan decision unit 1012 decides whether to add a spot. In this step, for example, the plan decision unit 1012 acquires a request regarding a reservation of an accommodation, a restaurant, an entertainment facility, a hands-on facility, a parking lot, etc. from the user. When YES in step S12, the routine proceeds to step S13. When NO in step S12, the routine proceeds to step S14.

In step S13, the plan decision unit 1012 decides a spot and plan the user is going to use. The process that is performed by the plan decision unit 1012 in step S13 will be described in more detail with reference to FIG. 11.

First, in step S131, the plan decision unit 1012 decides a spot the user is going to use (e.g., an accommodation).

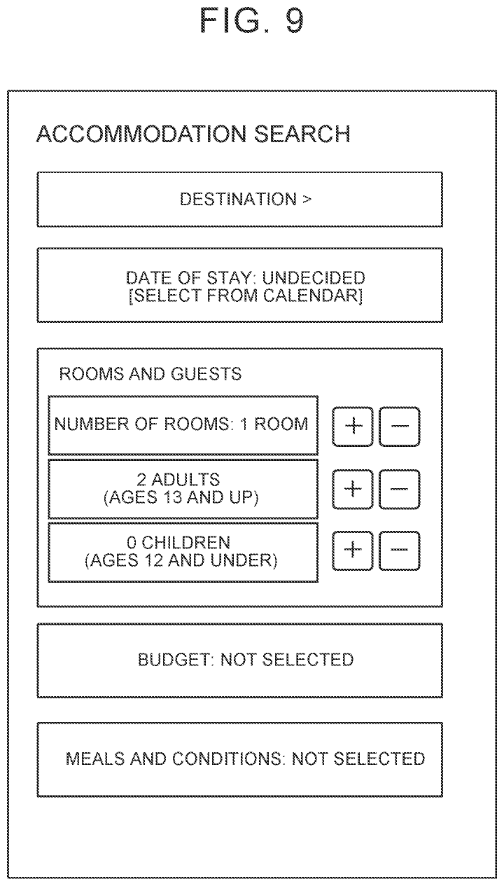

When the spot to be added is an accommodation, the plan decision unit 1012 decides an accommodation in step S131 based on the user's choice. The plan decision unit 1012 provides, for example, such an accommodation search screen as shown in FIG. 9 and allows the user to search for available accommodations.

In step S132, the plan decision unit 1012 decides a plan.

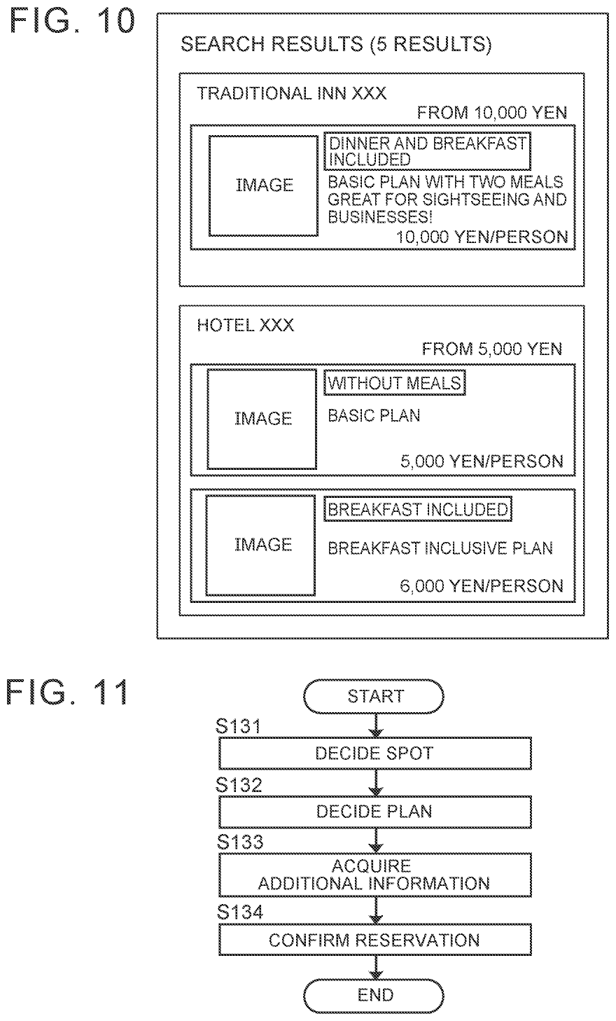

The plan search can be done by using existing technology. For example, the plan decision unit 1012 may provide such a list of plans as shown in FIG. 10 according to the search conditions entered via the screen illustrated in FIG. 9 and allow the user to choose a plan.

The plan decision unit 1012 can decide the plans available for reservations by, for example, referring to the plan data 102B and the reservation chart.

Next, in step S133, the plan decision unit 1012 acquires additional information regarding the use (additional information). When the spot is an accommodation, the plan decision unit 1012 acquires, for example, date and time information (in this example, check-in date and check-in time), number of guests, and their ages and genders as the additional information.

In this example, the spot is an accommodation. However, when the spot is a facility other than an accommodation, such as a restaurant, an entertainment facility, a hands-on facility, or a parking lot, the plan decision unit 1012 may acquire additional information suitable for the spot in step S133. For example, when the spot is a parking lot, the additional information can be information on the vehicle. When the spot is a hands-on facility, the additional information can be information on participants' ages etc.

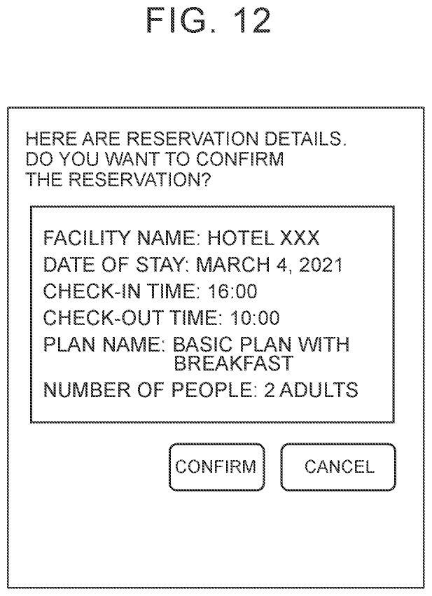

In step S134, the plan decision unit 1012 confirms the reservation based on the user's input. For example, the plan decision unit 1012 decides a plan via such a screen as shown in FIG. 12.

The flowchart of FIG. 8 shows an example in which a plurality of spots is added sequentially. However, before starting creating an itinerary, the plan decision unit 1012 may allow the user to specify conditions and may automatically extract and present combinations of spots and plans that meet the specified conditions. Such conditions include, for example, travel area, place of departure, date and time of departure, spots the user wishes to visit, genres of the spots the user wishes to visit, and date and time of return. The plan decision unit 1012 may automatically generate a recommended itinerary. The generated itinerary may be editable by the user. For example, the user may be allowed to add, delete, or replace a spot, or replace a plan.

Referring back to FIG. 8, the process that is performed by the reservation server 100 will further be described.

In step S14, the plan decision unit 1012 decides whether to arrange transportation.
In the present embodiment, the plan decision unit 1012 determines whether it is necessary to arrange transportation based on whether the user has a vehicle lease contract.
For example, when the contract data acquired in step S11 indicates that the user has a vehicle lease contract, the leased vehicle can be used as a means of transportation. Therefore, in this case, the plan decision unit 1012 can determine that it is not necessary to arrange transportation.
When the plan decision unit 1012 determines that it is not necessary to arrange transportation, the routine proceeds to step S16.
Even in this case, the plan decision unit 1012 may ask the user whether it is necessary to arrange transportation, and may determine whether it is necessary to arrange transportation based on the user's response. For example, the plan decision unit 1012 may ask the user whether the user wants to skip arrangement of transportation as the user has a vehicle lease contract.

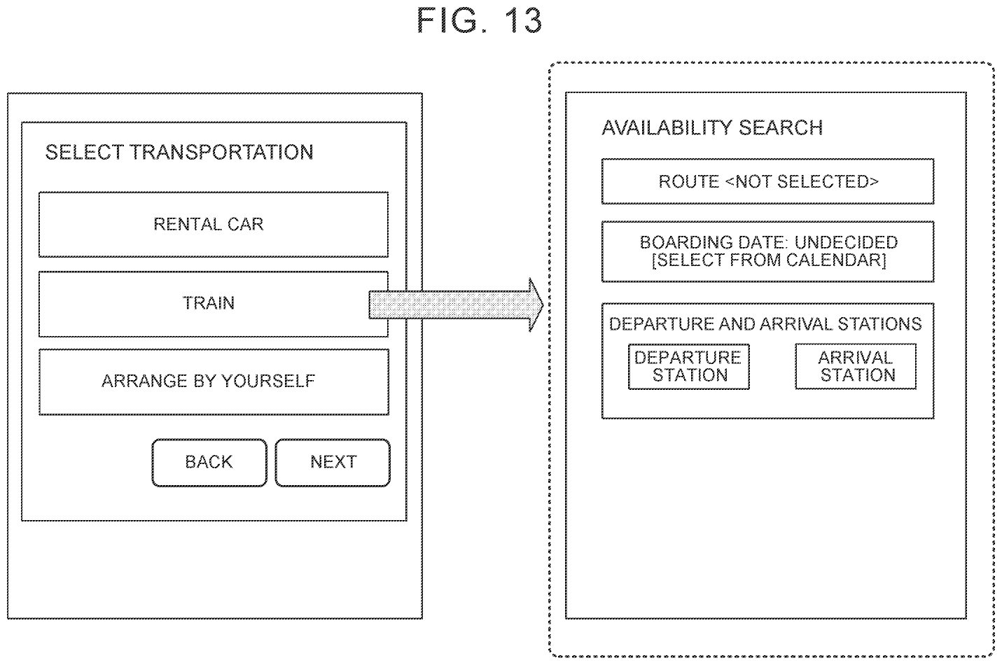

When arranging transportation, the plan decision unit 1012 presents such a screen as shown in FIG. 13 and decides the means of transportation the user is going to use and its details in step S15. In this step, the plan decision unit 1012 decides, for example, the place of departure, destination, route, and means of transportation the user is going to use. When the means of transportation the user wants to use requires a reservation, the plan decision unit 1012 may communicate with an external device in charge of that means of transportation and check availability etc. in this step. The external device is, for example, a device that provides a reservation service for trains, airplanes, taxis, or rental cars. When the plan decision unit 1012 decides not to arrange transportation in step S14, the plan decision unit 1012 skips the step of presenting a screen related to arrangement of transportation and booking transportation. In this case, the reservation may be executed when the spot and plan the user is going to use are confirmed.

Two or more means of transportation may be used during the trip. For example, the user may first move to a desired area by train and then move within the area by rental car. In this case, a facility that provides transportation (e.g., a taxi or rental car office) may be treated as a spot. In this case, the plan decision unit 1012 may decide a spot and a plan by a process similar to step S13.

In step S16, the reservation execution unit 1013 generates data for making reservations for the spots (and transportation) the user is going to use (reservation data). In this step, the reservation execution unit 1013 generates such reservation data as illustrated in

FIG. 7 and sends the reservation data to the external device(s) corresponding to one or more spots (or transportation) the user is going to use.

As described above, the reservation system according to the first embodiment that provides a service omits the step of booking transportation when the user has a vehicle lease contract with the first business operator. This provides convenience to users who use the service.

### Modification of First Embodiment

In the first embodiment, it is determined that it is not necessary to arrange transportation when the user has a vehicle lease contract. However, whether it is necessary to arrange transportation may be determined by using other information in addition to whether the user has a vehicle lease contract.

For example, when the seating capacity of the vehicle under lease is less than the number of people involved in movement (e.g., the number of people booked in an accommodation), not all of them can move by the vehicle. Therefore, in this case, it may be determined that it is necessary to arrange transportation. In this case, it may be recommended to book another vehicle with enough seating capacity, such as a rental car.
The number of people involved in movement may be determined based on information entered by the user. Information on the seating capacity of the vehicle under lease may be included in the contract data etc.

### Second Embodiment

The first embodiment illustrates an example in which the user makes individual reservations for a plurality of spots such as an accommodation and a restaurant. However, the reservation system may provide travel products that are packages including accommodation, meals, and a plurality of activities.

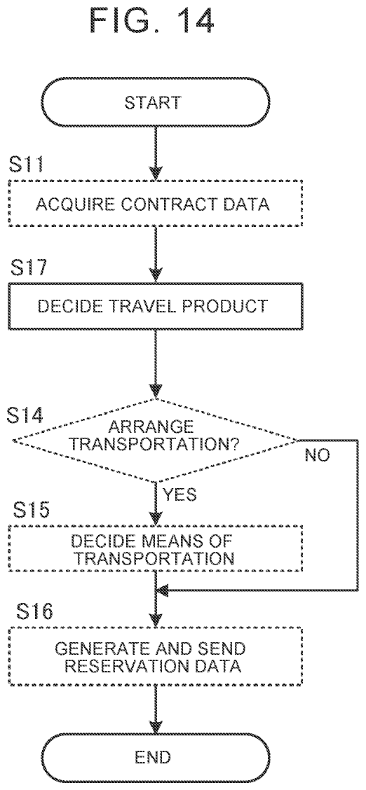

FIG. 14 is a flowchart of a process that is performed by the reservation server 100 in the present embodiment. The steps similar to those of the first embodiment are shown by dashed lines, and detailed description thereof will be omitted.

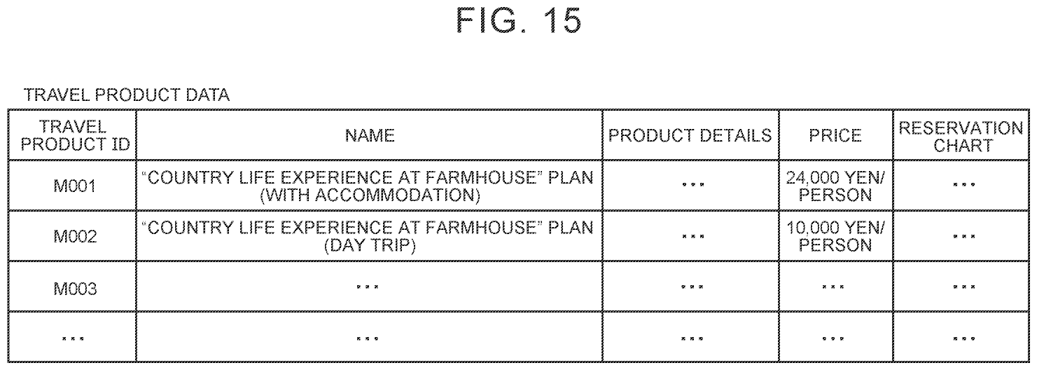

In the present embodiment, the plan decision unit 1012 decides a travel product in step S17. The storage unit 102 may store data defining the contents of travel products, instead of the spot data 102A and the plan data 102B. FIG. 15 shows an example of the data defining the contents of travel products.

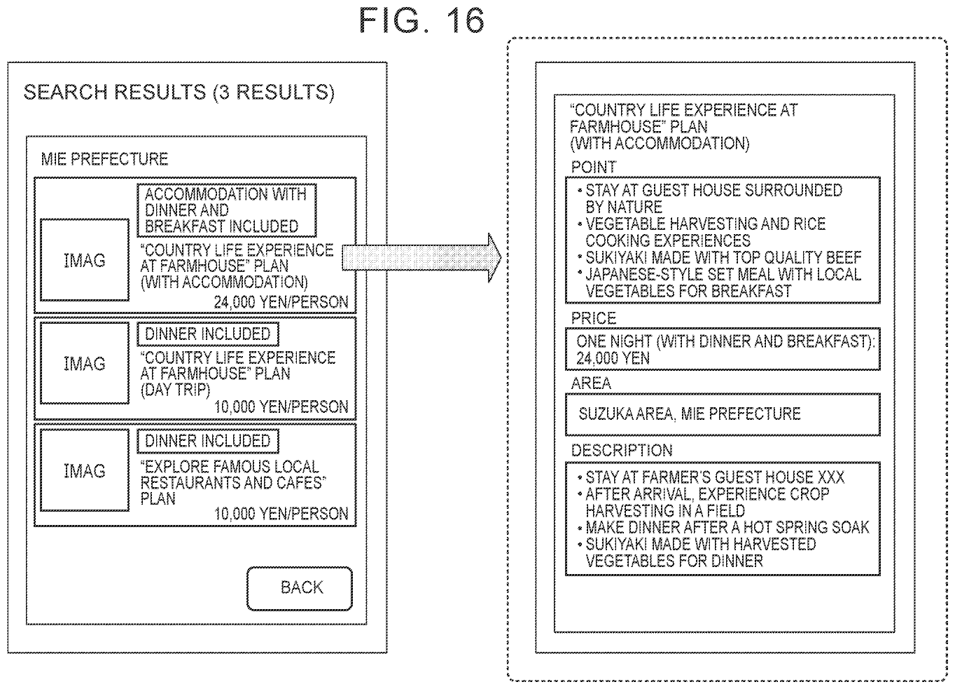

FIG. 16 shows an example of a screen that is provided to the user when deciding a travel product. For example, when the user specifies a desired area, the plan decision unit 1012 acquires a plurality of travel products for the specified area and presents the contents of the travel products to the user. The user can check the contents of each travel product and decide which travel product to purchase.

Step S14 and the subsequent steps are similar to those of the first embodiment.

As described above, the reservation system according to the first embodiment is also applicable to a system that provides travel package products.

### Other Modifications

The above embodiments are merely illustrative, and the present disclosure may be modified as appropriate without departing from the spirit and scope of the present disclosure.

For example, the processes and means described in the present disclosure may be combined as desired unless technical contradiction occurs.

In the description of the above embodiments, the service for making reservations for a plurality of spots is illustrated as the first service. However, the first service may be a service that does not involve reservations (e.g., a service that only provides information). For example, the first service may be a service for searching for a plurality of spots that offers coupons.

The first service may be a service for guiding a user to a plurality of websites the user needs to access in order to plan an itinerary. Examples of the websites include reservation websites operated by airlines, railway companies, travel agencies, and accommodations.

In this case, when the user has a vehicle lease contract with the first business operator, the process of guiding the user to the websites for booking transportation may be omitted.

The process described as being performed by a single device may be divided into a plurality of parts and performed by a plurality of devices. Alternatively, the processes described as being performed by different devices may be performed by a single device. In the computer system, the hardware configuration (server configuration) that implements functions may be flexibly changed.

The present disclosure may be embodied such that computer programs that implement the functions described in the above embodiments are supplied to a computer and are read and executed by one or more processors of the computer. Such computer programs may be provided to the computer by a non-transitory computer-readable storage medium that can be connected to a system bus of the computer, or may be provided to the computer via a network. Examples of the non-transitory computer-readable storage medium include: any type of disk or disc such as a magnetic disk (floppy (registered trademark) disk, hard disk drive (HDD), etc.) and an optical disc (compact disc ROM (CD-ROM), digital versatile disc (DVD), Blu-ray disc, etc.); a read only memory (ROM); a random access memory (RAM); an erasable programmable ROM (EPROM); an electrically erasable programmable ROM (EEPROM); a magnetic card; a flash memory; an optical card; and any type of medium suitable for storing electronic instructions.

What is claimed is:

1. An information processing device that provides a first service related to movement online, the information processing device comprising a processor configured to:
perform a first process regarding a reservation for a service a user is going to receive at a destination, and
perform a second process regarding a reservation for transportation the user is going to use, wherein
the processor is configured not to perform the second process when the user is using a second service that is a service for renting a vehicle and is going to use the first service.

2. The information processing device according to claim 1, wherein:
the processor is configured to provide a plurality of user interface screens to the user; and
the processor is configured not to provide at least a part of the user interface screens regarding the reservation for transportation when the user is using the second service.

3. The information processing device according to claim 2, wherein the processor is configured to propose to the user to skip the process regarding the reservation for transportation when the user is using the second service.

4. The information processing device according to claim 1, wherein the processor is configured to, in the first process, make a reservation for one or more spots the user is going to visit during the movement.

5. The information processing device according to claim 4, wherein the processor is configured to book public transportation in the second process.

6. The information processing device according to claim 1, wherein an operator of the first service is the same business operator as an operator of the second service or is a business operator related to the operator of the second service.

7. The information processing device according to claim 1, wherein the processor is configured to acquire data on a usage status of the second service by the user.

8. The information processing device according to claim 7, wherein the data includes information on a seating capacity of a first vehicle rented to the user.

9. The information processing device according to claim 8, wherein the processor is configured not to perform the second process when the number of people involved in the movement is smaller than the seating capacity of the first vehicle.

10. The information processing device according to claim 9, wherein the processor is configured to propose to the user to book a second vehicle with a larger seating capacity than the first vehicle when the number of people involved in the movement is larger than the seating capacity of the first vehicle.

11. An information processing system, comprising:
a first server that provides a first service related to movement online, the first server including a processor, the processor being configured to perform a first process regarding a reservation for a service a user is going to receive at a destination and a second process regarding a reservation for transportation the user is going to use, and the processor being configured not to perform the second process when the user is using a second service that is a service for renting a vehicle and is going to use the first service; and
a second server associated with the second service, the second server being configured to provide data on a usage status of the second service by the user to the first server.

12. The information processing system according to claim 11, wherein:
the processor is configured to provide a plurality of user interface screens to the user; and
the processor is configured not to provide at least a part of the user interface screens regarding the reservation for transportation when the user is using the second service.

13. The information processing system according to claim 12, wherein the processor is configured to propose to the user to skip the process regarding the reservation for transportation when the user is using the second service.

14. The information processing system according to claim 11, wherein the processor is configured to, in the first process, make a reservation for one or more spots the user is going to visit during the movement.

15. The information processing system according to claim 14, wherein the processor is configured to book public transportation in the second process.

16. The information processing system according to claim 11, wherein an operator of the first service is the same business operator as an operator of the second service or is a business operator related to the operator of the second service.

17. The information processing system according to claim 11, wherein the data includes information on a seating capacity of a first vehicle rented to the user.

18. The information processing system according to claim 17, wherein the processor is configured not to perform the second process when the number of people involved in the movement is smaller than the seating capacity of the first vehicle.

19. The information processing system according to claim 18, wherein the processor is configured to propose to the user to book a second vehicle with a larger seating capacity than the first vehicle when the number of people involved in the movement is larger than the seating capacity of the first vehicle.

20. An information processing method that provides a first service related to movement online, the information processing method comprising:
performing a process regarding a reservation for a service a user is going to receive at a destination by a computer; and
performing a process regarding a reservation for transportation the user is going to use by the computer when the user is not using a second service that is a service for renting a vehicle, and not performing the process regarding the reservation for transportation the user is going to use by the computer when the user is using the second service and is going to use the first service.
